(19) United States
(12) Patent Application Publication
(10) Pub. No.: US 2013/0032969 A1
(43) Pub. Date: Feb. 7, 2013

(54) PERMEABLE MATERIAL COMPACTING APPARATUS AND METHOD

(71) Applicants: Randall V. Guest, Spring, TX (US); Bennett M. Richard, Kingwood, TX (US)

(72) Inventors: Randall V. Guest, Spring, TX (US); Bennett M. Richard, Kingwood, TX (US)

(73) Assignee: BAKER HUGHES INCORPORATED, Houston, TX (US)

(21) Appl. No.: 13/204,167

(22) Filed: Aug. 5, 2011

(51) Int. Cl. B29C 43/46

(52) U.S. Cl. 264/175; 425/335

(57) ABSTRACT

A permeable material compacting method includes positioning permeable material around a mandrel, rotating the permeable material about an axis of the mandrel, longitudinally moving at least one tapered surface against the permeable material and reducing a radial thickness of the permeable material between a surface of the mandrel and the at least one tapered surface.

### BACKGROUND

Gravel packing is a process used in the downhole industry to fill an annulus with gravel. Gravel packed by such a process is permeable to fluid while providing support to walls of a wellbore in an earth formation, for example. The support prevents erosion and other damage to the formation walls that could result if the gravel support were not present. Recent developments replace the gravel pack with permeable space conforming materials that can expand to fill an annulus after being deployed therein. Such materials, as those described in U.S. Pat. No. 7,828,055 granted to Willauer et al. on Nov. 9, 2010, in U.S. Pat. No. 5,049,591 to Kaisha on Sep. 17, 1991 and methods as described in U.S. Pat. No. 7,644,773 to Richard on Jan. 12, 2010, the entire contents of which are incorporated herein by reference, require compaction or compression prior to being deployed. Methods and systems for compacting such materials are well received in the art.

### BRIEF DESCRIPTION

Disclosed herein is a permeable material compacting method. The method includes positioning permeable material around a mandrel, rotating the permeable material about an axis of the mandrel, longitudinally moving at least one tapered surface against the permeable material and reducing a radial thickness of the permeable material between a surface of the mandrel and the at least one tapered surface.

Further disclosed is a permeable material compacting apparatus which includes a mandrel and at least one roller having a tapered surface and an axis oriented substantially parallel to an axis of the mandrel. A first dimension between a first portion of the tapered surface and a surface of the mandrel is greater than a radial thickness of permeable material compactable between the mandrel and the at least one roller when non-compacted, and a second dimension between a second portion of the tapered surface and the mandrel is smaller than a radial thickness of the permeable material when non-compacted. The mandrel and the at least one roller are configured to compact the permeable material in response to relative longitudinal movement between the at least one roller and the mandrel.

### BRIEF DESCRIPTION OF THE DRAWINGS

The following descriptions should not be considered limiting in any way. With reference to the accompanying drawings, like elements are numbered alike:

FIG. 1 depicts a perspective view of a permeable material compacting apparatus disclosed herein; and

FIG. 2 depicts a partial cross sectional view of the permeable material compacting apparatus of FIG. 1.

### DETAILED DESCRIPTION

A detailed description of one or more embodiments of the disclosed apparatus and method are presented herein by way of exemplification and not limitation with reference to the Figures.

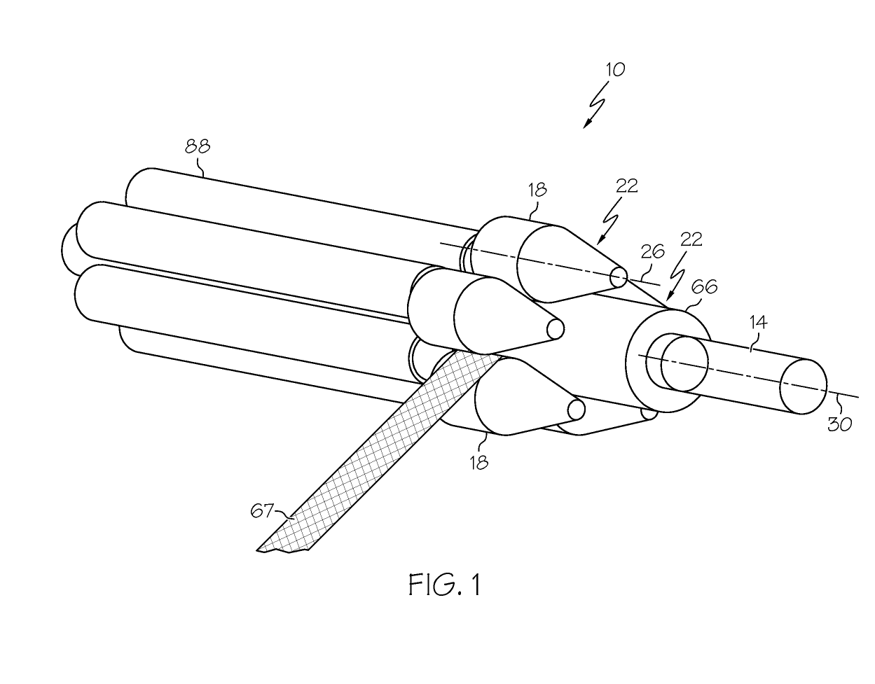

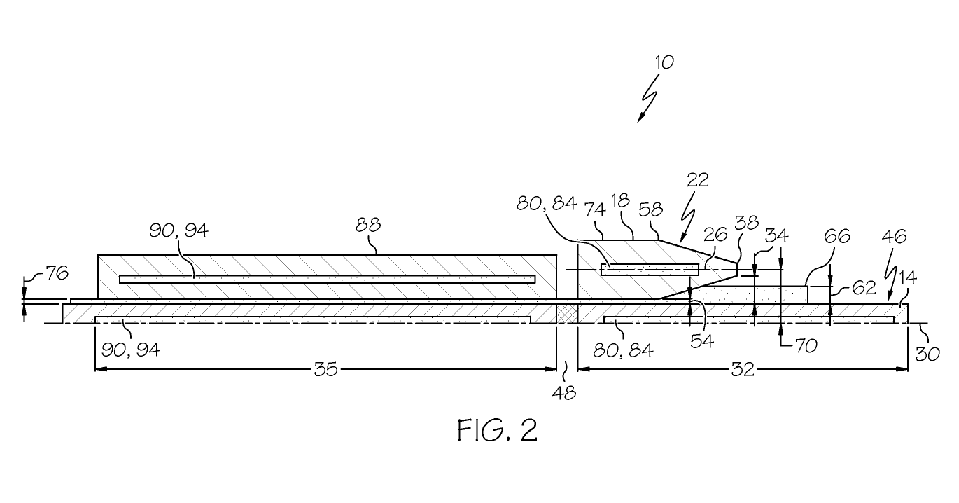

Referring to FIGS. 1 and 2, an embodiment of a permeable material compacting apparatus is illustrated at 10. The apparatus includes, a mandrel 14 and at least one roller 18, with six being shown herein, having a tapered surface 22 and an axis 26 oriented substantially parallel to an axis 30 of the mandrel 14. Though, the tapered surfaces 22 on the rollers 18 in this embodiment have a frustoconical shape, alternate embodiments are considered that have tapered surfaces 22 that are not frustoconical but instead change radial dimensions thereof in a nonlinear relationship to longitudinal displacement therealong. Regardless of the shape of the tapered surfaces 22, a first dimension 34 defined between a first portion 38 of the tapered surfaces 22 and a surface 46 of the mandrel 14 is greater than a second dimension 54 defined between a second portion 58 of the tapered surfaces 22 and the surface 46 of the mandrel 14. The first dimension 34 is selected to be greater than a radial thickness 62 of a permeable material 66 (in a non-compacted configuration) positionable around the mandrel 14 and compactable between the tapered surfaces 22 and the mandrel 14, while the second dimension is selected to be smaller than the radial thickness 62. The foregoing permeable material compacting apparatus 10 is configured to reduce volume of the permeable material 66 in response to relative longitudinal movement between the rollers 18 and the mandrel 14.

Each of the axes 26 of the six rollers 18 of the embodiment of the compacting apparatus 10 illustrated are displaced an equal dimension 70 from the axis 30 of the mandrel 14, although other, non-equal dimensions are contemplated for alternate embodiments. Additionally, each of the rollers 18 include a cylindrical portion 74 that is longitudinally displaced from the tapered surface 22. The cylindrical portion 74 is configured to maintain the permeable material 66 at a selected level of compression after having reached that level at the second portion 58 of the tapered surfaces 22. An optional heater 80 and/or cooler 84 in operable communication with the rollers 18 and the mandrel 14 can alter temperature of the rollers 18 and the mandrel 14 in a zone 32 that ends at a thermal break 48 near an end of the rollers 18. Then thorough contact between the permeable material 66 and one or both of the rollers 18 and the mandrel 14, can alter temperature of the permeable material 66. Some possible choices for use in the permeable material 66, such as polymeric based foam for example, have been found to accommodate a greater percentage of recoverable compression or compaction when compacted at elevated temperatures. As such, the heater 80 can serve the function of elevating temperatures of the permeable material 66 while it is being compacted.

It should be understood that the term permeable material as used herein covers any material that could serve as a filter to remove unwanted particulates from fluid passing therethrough. This filtration can be via flow through pores, cells or interstices, for example and as such, materials employable as the permeable material 66 include porous or cellular materials as well as membranes, mats and foams.

Additionally, these permeable materials 66 have been found to maintain a reduced volume after being compacted if the temperature is reduced while the materials are restrained in the compacted condition. As such, a cooler 94 in operable communication with the cylinders 88 and the mandrel 14 in a zone 35 defined between the thermal break 48 and an end of the mandrel 14 opposite the rollers 18 can serve the function of reducing temperatures of the permeable material 66 after it has been compacted, to freeze in or lock, in essence, the reduced volume condition. Subsequent increases in temperature of the permeable material 66 can allow stresses stored therewithin to expand the permeable material 66 back toward the volume it originally occupied prior to compaction. When employed in a downhole screen application, for example, the permeable material 66 can serve as a conformable screen that upon exposure to elevated temperatures and/or other conditions either anticipated to be encountered downhole or arranged by artifice to be downhole, can radially expand into conformable contact with walls of a formation.

Some high-loft materials, which, as initially assembled, are largely void, such as high-loft fiber mat, in order to serve their purpose downhole must be consolidated or compacted into a more dense layer. Additionally, some materials, while held in the consolidated or compacted arrangement require that the temperature of the fiber be raised to a determined temperature. Such materials are sometimes referred to as heat fusible mats. The rollers 18 and the mandrel 14 in the zone 32, both in operable communication with the cooler 84, may serve to compact such materials, and a heater 90 in operable communication with the cylinders 88 and the mandrel 14 may then be used to lock in the compacted or consolidated form by raising the temperature of the compacted permeable material 66 to the required value.

It should be noted that in addition to or in place of the cylinders 88, the cylindrical portion 74 of the rollers 18 might be arranged by artful design to perform the function of freezing the material. The sizes and positions of the rollers 18 relative to the mandrel 14, and more particularly relative to the zones 35 and 32 of the mandrel 14, may be similar to that of the cylinders 88, defining substantially a selected dimension 76 for maintaining compaction of the permeable material 66. As with the cylinders 88, the cylindrical portion 74 can also be in operable communication with the heater 90 and/or the cooler 94 for the same reason as they could be included in the cylinders 88.

The rollers 18 and the mandrel 14 can be rotationally driven to assist in drawing the permeable material 66 therebetween while minimizing shear stress applied thereto. The rollers 18 are moved longitudinally in relation to the mandrel 14 while the permeable material 66 is positioned around the mandrel 14. This relative motion causes the permeable material 66 to be compacted starting at one longitudinal end thereof and moving toward the other longitudinal end thereof

Optionally, a restraining material 67 such as a thin web may be introduced to wrap around the permeable material 66. The restraining material 67 can help provide and retain the dimension 76 of the permeable material 66 by tension in the restraining material 67 supplied during winding and optionally by heat-induced shrinking caused by contact with the rollers 18 and the permeable material 66 while it is hot, provided that the restraining material 67 consists of heat-shrinking material. The restraining material 67 may also serve as a protective covering to prevent soiling or damage during subsequent handling and shipping. The restraining material 67 may be fed and tensioned by web handling equipment (not shown). The restraining material 67 may be fed at the line of contact between the cylindrical portion 74 of the rollers 18, to help maintain the permeable material 66 at the dimension 76 while the permeable material 66 is rotated between perimetrically adjacent sets of the rollers 18.

In another embodiment, the longitudinal length of the cylindrical portion 74 of the rollers 18 can be as long as desired, including being the full longitudinal length of the permeable material 66. In such an embodiment the separate cylinders 88 would be eliminated since the cylindrical portion 74 of the rollers 18 would provide their function. In this embodiment the restraining material 67 would be sized to cover the full longitudinal length of the cylindrical portion 74 and the length of the permeable material 66 being compacted thereby. With the full length of the permeable material 66 being wrapped by the restraining material 67 the need to freeze-in through a specific cooling step may be eliminated since the compacted condition can be maintained by the restraining material 67 while the permeable material 66 naturally cools to that of an ambient temperature. The rollers 18 could even be withdrawn from the permeable material 66 while the natural cooling is taking place. Additional cording, webbing or stripping may be employed to assure that the permeable material 66 is maintained at the dimension 76 during the cooling. Potential materials for use in the restraining material 67 include, Kapton (registered trademark of DuPont Corp.), nylon and FEP (fluorinated ethylene propylene), for example.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A permeable material compacting method comprising:
positioning permeable material around a mandrel;
rotating the permeable material about an axis of the mandrel;
longitudinally moving at least one tapered surface against the permeable material; and
reducing a radial thickness of the permeable material between a surface of the mandrel and the at least one tapered surface.

2. The permeable material compacting method of claim 1, further comprising heating at least one of the mandrel and the at least one tapered surface.

3. The permeable material compacting method of claim 1, further comprising cooling at least one of the mandrel and the at least one tapered surface.

4. The permeable material compacting method of claim 1, further comprising rotating the at least one tapered surface.

5. The permeable material compacting method of claim 1, further comprising longitudinally moving at least one cylinder relative to at least one of the permeable material and the mandrel.

6. The permeable material compacting method of claim 5, further comprising cooling the at least one cylinder.

7. The permeable material compacting method of claim 5, further comprising heating the at least one cylinder.

8. The permeable material compacting method of claim 1, further comprising heating the permeable material prior to reducing the radial thickness thereof.

9. The permeable material compacting method of claim 1, further comprising cooling the permeable material subsequent to reducing the radial thickness thereof.

10. The permeable material compacting method of claim 1, further comprising wrapping the permeable material with restraining material.

11. A permeable material compacting apparatus, comprising:
a mandrel; and
at least one roller having a tapered surface and an axis oriented substantially parallel to an axis of the mandrel, a first dimension between a first portion of the tapered surface and a surface of the mandrel being greater than a radial thickness of permeable material compactable between the mandrel and the at least one roller when non-compacted, and a second dimension between a second portion of the tapered surface and the mandrel being smaller than a radial thickness of the permeable material when non-compacted, the mandrel and the at least one roller being configured to compact the permeable material in response to relative longitudinal movement between the at least one roller and the mandrel.

12. The permeable material compacting apparatus of claim 11, wherein the at least one roller is a plurality of rollers each having an axis positioned substantially an equal dimension from the axis of the mandrel.

13. The permeable material compacting apparatus of claim 12, wherein the plurality of rollers is six.

14. The permeable material compacting apparatus of claim 11, wherein the at least one roller also includes a cylindrical surface portion.

15. The permeable material compacting apparatus of claim 11, wherein the cylindrical surface portion is longitudinally adjacent to the tapered surface.

16. The permeable material compacting apparatus of claim 11, further comprising at least one cylinder having an axis substantially parallel to the axis of the mandrel displaced longitudinally of the at least one roller in a direction in increasing dimension of the tapered surface.

17. The permeable material compacting apparatus of claim 16, wherein the at least one cylinder is configured to maintain a radial thickness of permeable material positioned between a surface thereof and a surface of the mandrel.

18. The permeable material compacting apparatus of claim 16, wherein the at least one cylinder is configured to cool permeable material contactable therewith.

19. The permeable material compacting apparatus of claim 16, wherein the at least one cylinder is configured to heat permeable material contactable therewith.

20. The permeable material compacting apparatus of claim 11, wherein at least one of the mandrel and the at least one roller include a heater.

21. The permeable material compacting apparatus of claim 11, wherein at least one of the mandrel and the at least one roller include a cooler.

22. The permeable material compacting apparatus of claim 11, wherein the permeable material is foam.

23. The permeable material compacting apparatus of claim 11, wherein the permeable material is heat fusible mat.

24. The permeable material compacting apparatus of claim 11, wherein at least one of the mandrel and the at least one roller are rotational driven.

25. The permeable material compacting apparatus of claim 11, wherein the tapered surface is frustoconical.
